(19) United States
(12) Patent Application Publication
(10) Pub. No.: US 2026/0323276 A1
(43) Pub. Date: Oct. 15, 2026

(54) SYSTEMS AND METHODS FOR CELLULAR CLOAKING OF MOBILE COMMUNICATION DEVICES

(71) Applicant: University of Maryland, College Park, College Park, MD (US)

(72) Inventor: Ernest Ray Boatwright, III, Arlington, VA (US)

(21) Appl. No.: 19/647,096

(22) Filed: Apr. 14, 2026

Related U.S. Application Data
(60) Provisional application No. 63/788,916, filed on Apr. 15, 2025.

(51) Int. Cl. H04W 12/03; H04W 36/08

(52) U.S. Cl. CPC H04W 12/03; H04W 36/08

(57) ABSTRACT

A system for cloaking a mobile communication device includes a random number generator, a plurality of cellular modems, a controller, and a memory. The controller executes the instructions causing the system to, and a method for cloaking a mobile communication device includes, selecting, at random, a replacement combination of identifiers including a device identifier and a subscriber identifier and replacing, at random, a currently active combination of identifiers for the mobile communication device with the selected replacement combination of identifiers for the mobile communication device.

### CROSS-REFERENCE TO RELATED APPLICATIONS

This application claims the benefit of, and priority to, U.S. Provisional Patent Application No. 63/788,916, filed on April 15, 2025, the entire contents of which are hereby incorporated herein by reference.

### TECHNICAL FIELD

The present disclosure relates generally to mobile communication device privacy and, more particularly, to hardware-based systems and methods for automated identity and/or location obfuscation for mobile communication devices.

### BACKGROUND

Mobile communication devices have become central to modern communication, commerce, and personal organization, resulting in most mobile communication devices remaining in constant connectivity with a cellular network. This persistent connectivity, while convenient, makes mobile communication devices susceptible to tracking through hardware and subscriber identifiers, as well as location triangulation.

Existing methods for maintaining user anonymity, such as prepaid “burner” phones and Subscriber Identity Module (SIM) cards, require frequent manual replacement and physical transactions, which are often traceable. These approaches also pose logistical challenges and can still expose users to identification risks through purchase records or surveillance.

### SUMMARY

Provided in accordance with aspects of the present disclosure is a system for cloaking a mobile communication device including a random number generator, a plurality of cellular modems, a controller, and a memory. The memory stores instructions that, when executed by the controller, cause the system to: select, at random, a replacement combination of identifiers for use in connecting a mobile communication device to a network, wherein the replacement combination of identifiers includes a device identifier and a subscriber identifier different from a device identifier and a subscriber identifier, respectively, of a current combination of identifiers currently used to connect the mobile communication device to the network; and replace, at random, the currently active combination of identifiers with the selected replacement combination of identifiers for the mobile communication device.

In aspects, at least one of the selection at random or the replacement at random is based on a random seed generated by the random number generator.

In aspects, a first cellular modem of the plurality of cellular modems is used to connect the mobile communication device to the network using the current combination of identifiers, a second cellular modem of the plurality of cellular modems has the selected replacement combination of identifiers assigned thereto, and the replacing includes performing a handoff from the first cellular modem to the second cellular modem to connect the mobile communication device to the network using the second cellular mode and the replacement combination of identifiers.

In aspects, the instructions, when executed by the controller, further cause the system to start a call using a first data connection to the network using the first cellular modem. In such aspects, the handoff can include switching from the first data connection using the first cellular modem to a second data connection to the network using the second cellular modem. The call is thus continued using the second data connection using the second cellular modem.

In aspects, starting the call using the first data connection includes assigning a first random phone number and performing the handoff to continue the call using the second data connection includes assigning a second random phone number.

In aspects, each device identifier includes at least an International Mobile Equipment Identity (IMEI) and/or each subscriber identifier includes at least an International Mobile Subscriber Identity (IMSI).

In aspects, the random number generator is a Quantum Random Number Generator (QRNG) or a Single-Photon Avalanche Diode (SPAD) sensor.

In aspects, the replacement combination of identifiers is selected from a pool of combinations stored in a memory accessible by the controller. In such aspects, at least a portion of the pool of combinations can be obtained from previously used devices taken out of service.

In aspects, the instructions, when executed by the controller, further cause the system to modify, at random, transmission signal power from the mobile communication device to disrupt signal strength-based triangulation.

In aspects, the instructions, when executed by the controller, further cause the system to maintain active connectivity to the network during the replacement of the combination of identifiers.

In aspects, the controller includes an FPGA or ASIC.

Also provided in accordance with the present disclosure is a mobile communication system including a mobile communication device and the system for cloaking a mobile communication device according to any one or more of the above aspects or other aspects detailed herein. The system for cloaking a mobile communication device is incorporated into or connected with the mobile communication device.

A method for cloaking a mobile communication device provided in accordance with the present disclosure includes selecting, at random, a replacement combination of identifiers for use in connecting a mobile communication device to a network. The replacement combination of identifiers includes a device identifier and a subscriber identifier different from a device identifier and a subscriber identifier, respectively, of a current combination of identifiers currently used to connect the mobile communication device to the network. The method further includes replacing, at random, the currently active combination of identifiers with the selected replacement combination of identifiers for the mobile communication device.

In aspects, at least one of the selection at random or the replacement at random is based on a random seed generated by a random number generator.

In aspects, the replacing includes performing a handoff from a first cellular modem to a second cellular modem to connect the mobile communication device to the network using the second cellular mode and the replacement combination of identifiers.

In aspects, the method further includes starting a call using a first data connection to the network using the first cellular modem, wherein performing the handoff includes switching from the first data connection using the first modem to a second data connection to the network using the second cellular modem. The method, in such aspects, further includes, continuing the call using the second data connection using the second cellular modem.

In aspects, each device identifier includes at least an International Mobile Equipment Identity (IMEI) and/or each subscriber identifier includes at least an International Mobile Subscriber Identity (IMSI).

In aspects, the replacement combination of identifiers is selected from a pool of combinations stored in a memory accessible by the controller. In such aspects, at least a portion of the pool of combinations can be obtained from previously used devices taken out of service.

In aspects, the method further includes modifying, at random, transmission signal power from the mobile communication device to disrupt signal strength-based triangulation.

In aspects, the method further includes maintaining active connectivity to the network during the replacement of the combination of identifiers.

### BRIEF DESCRIPTION OF THE DRAWINGS

Aspects and features of this disclosure will become more apparent by reference to the following detailed description that sets forth illustrative aspects, and the accompanying drawings of which:

FIG. 1 illustrates an exemplary system for obfuscating mobile communication device identity and location in accordance with aspects of the present disclosure;

FIG. 2 is a block diagram of a controller configured for use with the system of FIG. 1 in accordance with aspects of the present disclosure;

FIGS. 3 and 4 are flow diagrams of methods for obfuscating mobile communication device identity in accordance with aspects of the present disclosure;

FIG. 5 is a schematic illustration of obfuscating mobile communication device identity as in FIGS. 3 and/or 4 in accordance with aspects of the present disclosure;

FIG. 6 is a block diagram representing the storage of a plurality of combinations of device identifiers and subscriber identifiers configured for use in accordance with aspects of the present disclosure; and

FIG. 7 is a flow diagram of a method for obfuscating mobile communication device location in accordance with aspects of the present disclosure.

### DETAILED DESCRIPTION

While there exists methods for maintaining user anonymity while using mobile communication devices, such as by using prepaid “burner” phones and Subscriber Identity Module (SIM) cards, there remains a need for a more seamless and automated manner of preserving user privacy in using mobile communication devices while maintaining continuous mobile network access. The present disclosure facilitates user privacy while maintaining continuous mobile network access for a mobile communication device in a seamless and automated manner. More specifically, the present disclosure provides hardware-based systems and methods for automated identity and/or location obfuscation in mobile communication devices, also referred to herein as cloaking.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary configurations illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

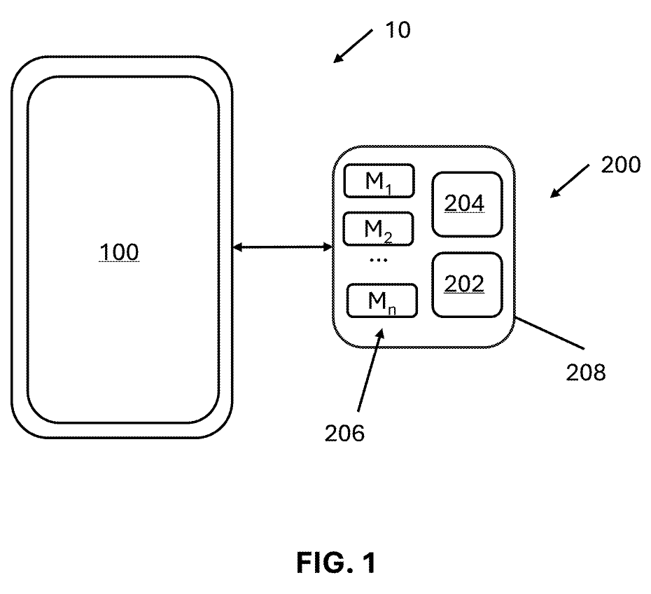

Referring to FIG. 1, a system for mobile communication device cloaking in accordance with the present disclosure is shown generally identified by reference numeral 10. System 10 includes a mobile communication device 100 and a cloaking device 200 configured for cloaking mobile communication device 100 to obfuscate identity and location details associated with mobile communications device 100. Cloaking device 200 may be separate from mobile communication device 100, e.g., wherein cloaking device 200 is housed within an enclosure 206 separate from the enclosure housing mobile communication device 100. In such aspects, cloaking device 200 can physically connect to a data port, e.g., a Universal Serial Bus (USB) port, of mobile communication device 100, and/or wireless connect to mobile communication device 100, e.g., via Bluetooth®, Near Field Communication (NFC), or in any other suitable manner.

Alternatively, cloaking device 200 can be incorporated into mobile communication device 100, e.g., as circuit within mobile communication device 100 (and within the enclosure of mobile communication device 100). In such aspects, cloaking device 200 can be installed during manufacture of mobile communication device 100 or can be retrofitted into mobile communication device 100 using secure hardware extensions. For retrofitting, the components, e.g., at least the Field-Programmable Gate Array (FPGA) or Application-Specific Integrated Circuit (ASIC), of cloaking device 200 of may be implemented as a secure enclave connected via standard internal interfaces such as USB, Inter-Integrated Circuit (I2C), or Serial Peripheral Interface (SPI). The firmware may reside in protected memory and be verified through cryptographic signatures at boot. Tamper-detection and rollback prevention mechanisms may be included to protect the integrity of the identity and location management features. Such configurations help ensure compliance with privacy and security standards.

Mobile communication device 100 may be any suitable device configured to connect to a cellular network (e.g., including a cellular modem) such as, for example and without limitation, a smartphone, tablet, laptop, wearable device (e.g., smartwatch), mobile hotspot, portable media player, digital camera, navigation (e.g., GPS) device, mobile gaming console, vehicle, or Internet of Things (IoT) device. Thus, as utilized herein, “mobile communication device” refers to a device configured to connect to a cellular network such as, for example, via a cellular modem of or connected to the device.

Cloaking device 200 includes a controller 202, a random number generator 204, and a plurality of cellular modems 206 (e.g., M₁, M₂, …, Mₙ). Random number generator 204 can be a quantum random number generator (QRNG), a Single-Photon Avalanche Diode (SPAD) sensor, or any other suitable device enabling random number generation.

Controller 202 of cloaking device 200 is configured, as described in greater detail below, to store, provision, and dynamically implement multiple different combinations of device and subscriber identifiers and/or cellular modems using, for example, an FPGA or ASIC. The device identifiers can be in the form of, for example, an International Mobile Equipment Identity (IMEI) and/or an Integrated Circuit Card Identifier (ICCID). The subscriber identifiers can be in the form of, for example, an International Mobile Subscriber Identity (IMSI) and/or a Mobile Station International Subscriber Directory Number (MSISDN). Other suitable device and/or subscriber identifiers are also contemplated. Controller 202, in aspects, is further configured to adjust the transmission power at which mobile communication device 100 communicates with a network at randomized intervals, thereby disrupting cellular triangulation methods to obfuscate the true physical location of mobile communication device 100.

Random number generator 204 is configured to generate non-deterministic random values that determine the timing and/or selection of identifier changes, cellular modem changes, and/or transmission power modulation. In aspects, random number generator 204 may be a random number generator of mobile communication device 100. Alternatively, or additionally, random number generator 204 may be integral with cloaking device 200.

The plurality of cellular modems 206 (e.g., M₁, M₂, …, Mₙ) is configured to enable cycling of phone numbers, device identifiers, and/or subscriber identifiers during network connection without service disruption, including during a single cellular telephone call without disruption. For example, cloaking device 200 and mobile communication device 100 may operate to enable starting a call using a data connection using a first cellular modem, activate a first Session Initiation Protocol (SIP)-based communication terminal to enable mobile communication device 100 to participate in Voice over IP (VoIP) communication (such as, for example, calls, messaging, etc.), assign a randomized first phone number (device identifier, and/or subscriber identifier) to mobile communication device 100, replace, at a randomized time interval, the first phone number (device identifier, and/or subscriber identifier) for mobile communication device 100 with a second phone number (device identifier, and/or subscriber identifier), and activate a second SIP-based communication terminal (to participate in Voice over IP (VoIP) communication (such as, for example, calls, messaging, etc.)), using a second cellular modem, and continue the call using a data connection using the second modem, without disruption of the call between the handoff from the first cellular modem (and first phone number, device identifier, and/or subscriber identifier) to the second cellular modem (and second phone number, device identifier, and/or subscriber identifier). The above-detailed handoff may likewise proceed without noticeable disruption for data communications as well.

The systems and methods of the present disclosure, in aspects, address the technical problem of persistent mobile communication device traceability due to static hardware and subscriber identifiers and predictable signal characteristics used for location tracking. The systems and methods of the present disclosure, in aspects, provide the technical solution of at least using a random number generator and a dedicated FPGA or ASIC to dynamically rotate device identifiers (such as IMEI) and subscriber identifiers (such as IMSI) at randomized intervals. Additionally, the systems and methods of the present disclosure provide the technical solution of at least modulating a transmission signal power used by the mobile communication device to communicate with a cellular network to disrupt conventional location triangulation methods used by cellular networks. By automating these obfuscation processes within the hardware and firmware of the mobile communication device (or cloaking device connected to the mobile communication device), reliance on manual intervention or physical device replacement is eliminated, thereby providing a scalable and technically robust solution for enhancing user privacy while preserving seamless network connectivity.

In conventional mobile systems, devices are uniquely identified by static values such as the IMEI, IMSI, ICCID, and/or MSISDN. These identifiers are stored on the device and in its associated SIM card and remain fixed for the duration of device ownership or SIM card usage. Over time, repeated communication with cellular towers, apps, and services enables profiling of the mobile communication device, user, and their behavior patterns. Even when the user replaces a SIM card or mobile communication device, the transition may be traceable through location continuity or account metadata. This persistent identification capability presents a challenge for users seeking anonymity or privacy.

The systems and methods described herein overcome this limitation by relocating identity management functions from the mobile communication device’s processor to an independent hardware component, e.g., an FPGA, ASIC, or other suitable hardware component, e.g., of the cloaking device. The cloaking device generates, stores, and switches between identity profiles. These profiles include combinations of valid device and subscriber identifiers, with each combination capable of being presented to cellular networks as an authentic, standalone identity combination. By isolating this functionality into a hardware component, e.g., an FPGA or ASIC of cloaking device 200 (whether incorporated into or separate from mobile communication device 100), the systems and methods of the present disclosure are able to perform identity operations without reliance on native SIM management infrastructure of the mobile communication device.

The disclosed systems and methods provide a benefit over systems and methods that obscure calls (or other network communications) on the server side, in that server-side solutions are just private networks and the user’s identity is stored on this private network and can still be determined.

Identity profile switching occurs at randomized intervals generated by the random number generator. The random number generator, e.g., a QRNG or SPAD sensor, provides high-entropy, non-deterministic values that are used as seeds to trigger identity changes and/or timings. These identity changes may include switching the IMEI, IMEISV, IMSI, ICCID, and/or MSISDN values presented by the mobile communication device to the cellular network. Because the profiles are provisioned in advance and stored in the FPGA or ASIC (or other suitable hardware component), each identity change can occur instantaneously without requiring user interaction or rebooting the mobile communication device, and without disruption of network connectivity. These changes may occur while the device is idle, in use, or actively connected to a network, and are not limited by session state.

In order to support multiple simultaneous identities and ensure uninterrupted service during transitions, the system implements core functionality from eSIM (embedded SIM) and rSIM (reprogrammable SIM) standards within the FPGA or ASIC hardware. These standards allow for secure storage of multiple operator profiles, and dynamic switching without physical SIM card replacement. The present disclosure extends this capability by associating these profiles with randomized device identifiers. This enables a high degree of modularity, where a single physical device can represent a multitude of virtual devices. Importantly, these identity transitions are imperceptible to the user and do not affect their experience of voice or data services.

In addition to identity obfuscation, the system includes a signal power modulation function that varies the transmission power of communication signals transmitted from the mobile communication device to the network in a randomized fashion. This variability directly impacts the ability of cellular towers to accurately triangulate the position of the mobile communication device based on received signal strength. Cellular triangulation depends on consistent power output to calculate distance from multiple towers, and introducing controlled randomness disrupts this calculation. The random number generator is again used to produce fluctuation patterns that are truly unpredictable and non-repetitive such that the signal power modulation is random. These fluctuations serve to further decouple the mobile communication device from its real-time location, adding a layer of spatial anonymity.

The systems and methods of the present disclosure operate independently of Global Positioning System (GPS), Wi-Fi-based location services, and other conventional positioning technologies. Users may optionally disable location-based services as part of their selected privacy mode. However, even when those features are deactivated, cellular towers still attempt to estimate mobile communication device location using signal characteristics. The modulation of transmission power, combined with randomized timing, prevents these systems from generating accurate location estimates. As a result, even service providers are unable to confidently correlate the presence of the mobile communication device with a specific place over time.

The systems and methods of the present disclosure include a privacy configuration interface that allows users to select from three operating modes: Normal, Random Location, and Cloaked. In Normal mode, the system disables all obfuscation functionality and allows the mobile communication device to function as a standard mobile communication device, e.g., smartphone. All hardware identifiers remain fixed, location services are active, and transmission power is unaltered. This mode supports full compatibility with applications that depend on consistent identifiers or accurate location. It is suitable for users who temporarily require standard functionality, such as navigation or online banking.

In Random Location mode, the system disrupts location-based tracking. GPS, Wi-Fi triangulation, and cellular tower positioning are disabled by default. The random number generator drives changes to the transmission signal power of the mobile communication device at random intervals and degrees to simulate movement within a virtual geographic area. This randomized movement pattern is generated in a bounded zone defined by the user or a preset configuration, such as a five-mile radius. The mobile communication device remains functional for communication but does not present accurate location data to apps or network operators in this Random Location mode.

Users operating in Random Location mode may notice limited functionality in map-based services or applications that rely on precise location. However, the system preserves the ability to route emergency services by transmitting randomized coordinates within the virtual zone. These coordinates are sufficient for general routing but do not reflect the true position of the mobile communication device. This compromise balances privacy with accessibility to life-critical services. The user interface may include warnings or indicators to notify the user of such trade-offs.

In Cloaked mode, the system activates both identity and location obfuscation simultaneously. The identifiers, e.g., device and subscriber identifiers including, for example, IMEI, IMSI, ICCID, and/or MSISDN, are randomized at intervals determined by the random number generator, and transmission power levels are modulated randomly (and, in aspects, continuously). This dual-layer approach maximizes anonymity by masking the identity and behavior of the mobile communication device. From the perspective of the cellular network, the mobile communication device appears as a series of unrelated, sporadically active mobile communication devices with inconsistent location behavior. This makes it extremely difficult to construct a persistent user or device profile.

To ensure reliability during identity changes, the systems and methods of the present disclosure employ a network integrity validation process. Before an identity transition is completed, the system verifies that the selected profile is compatible with current network parameters, such as frequency bands, authentication tokens, and region-specific requirements. If a profile fails validation, it is discarded, and a new one is selected. This ensures that users do not experience dropped connections or failed registration attempts during obfuscation cycles. The process is managed entirely in firmware and occurs without noticeable delay.

The transmission signal power modulation may include bounds-checking to preserve connectivity while disrupting triangulation. For example, the controller may set minimum and maximum thresholds for transmit power to ensure the device remains within acceptable link margins for cellular communication. These bounds may be adjusted dynamically based on environmental factors or user preferences. For example, in weak signal areas, the system may reduce the amplitude of fluctuations to prevent loss of service. This adaptability provides the technical benefit of making the system resilient in a variety of operating conditions.

To further enhance the randomness of location simulation, the system may incorporate time-based entropy and environmental inputs alongside random number generation output. These inputs include accelerometer readings, ambient temperature, and device usage patterns, which are used to generate plausible movement vectors. These vectors are not tied to actual motion but are realistic enough to avoid detection by anomaly filters used in analytics or fraud detection systems. As a result, the simulated location appears authentic without revealing any true movement data. In aspects, implementations of location simulation or spoofing randomness may be made more robust and context-aware by including: timestamps or time-based entropy (e.g., current time, intervals, patterns), sensor data like accelerometer input, orientation, temperature, and/or usage patterns to make simulation harder to detect by anomaly detection systems.

In terms of implementation, the system architecture is modular and designed to operate independently of the baseband processor and operating system of the host mobile communication device. By abstracting identity and signal functions to the FPGA or ASIC, the system avoids dependency on proprietary software stacks or manufacturer-specific Application Programming Interfaces (APIs). This increases portability and reduces the complexity of adapting the system to new mobile communication devices and minimizes the risk of detection or tampering by third-party software.

The described systems and methods offers a comprehensive technical framework for enhancing mobile communication device privacy through real-time identity rotation and location signal manipulation. Unlike conventional methods that rely on physical burner devices or manual SIM swaps, the disclosed approach operates autonomously and continuously. By combining hardware-backed randomness, secure provisioning, and adaptive signal control, the system provides scalable protection against long-term tracking and surveillance. It is designed to maintain usability, service continuity, and compliance with communication standards while significantly improving user privacy. This balance of security and functionality positions the system as a novel solution to the growing challenges of mobile communication device traceability.

The present disclosure, in aspects, provides privacy-enhancing systems and methods embedded within a mobile communication device, wherein the systems and methods, more specifically, provide hardware-based obfuscation of device and subscriber identities, as well as location. The disclosed systems and methods integrate firmware and a dedicated hardware component, e.g., FPGA or ASIC, to carry out its operations in a seamless and automated manner. The core objective is to reduce the traceability of mobile devices, in terms of location and/or identity, without disrupting ongoing communication sessions or requiring manual changes by the user. This is accomplished by dynamically (e.g., randomly) changing identity credentials and modifying radio transmission characteristics under the control of a random number generator. These processes take place in real-time and continue whether the mobile communication device is active or idle.

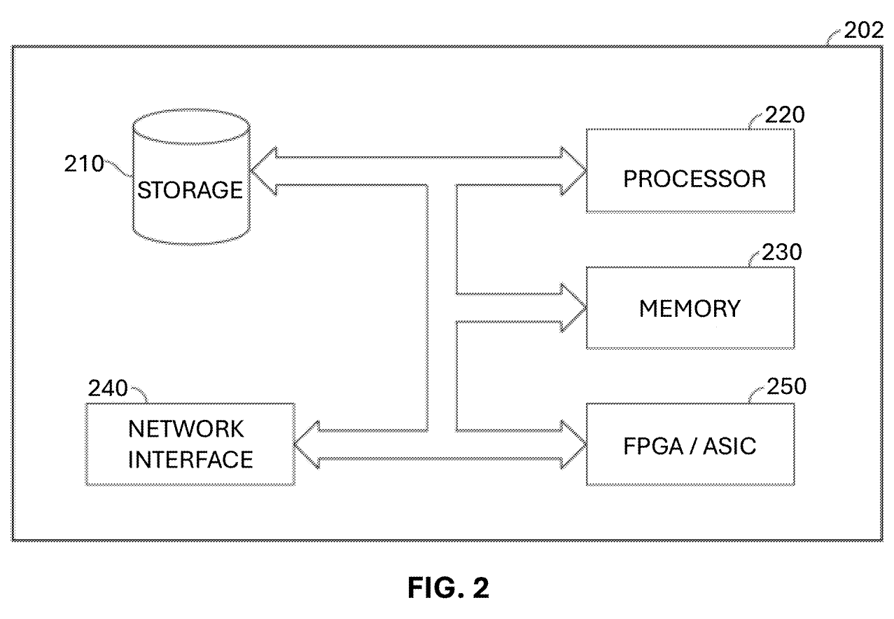

FIG. 2 illustrates an exemplary controller 202 of cloaking device 200 (FIG. 1). Controller 202 includes a processor 220 connected to a computer-readable storage medium or a memory 230. The controller 202 may be used to control and/or execute operations of cloaking device 200 (FIG. 1). The computer-readable storage medium or memory 230 may be a volatile type of memory, e.g., RAM, or a non-volatile type of memory, e.g., flash media, disk media, etc. In various aspects of the present disclosure, the processor 220 may be a digital signal processor, a microprocessor, an ASIC, a graphics processing unit (GPU), an FPGA, or a central processing unit (CPU). In alternative or additional aspects, controller 202 can include both processor 220 and an FPGA/ASIC 250. In aspects of the disclosure, network inference may be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 202 and can communicate with the processor 220 through communication buses of a circuit board and/or through communication cables such as serial ATA cables or other types of cables. The memory 230 includes computer-readable instructions that are executable by the processor 220 to operate the controller 202. In other aspects of the present disclosure, the controller 202 may include a network interface 240 to communicate with other computers or to a server. A storage device 210 may be a memory used for storing data. The disclosed method may run on the controller 202 or on a user device, including, for example, on a mobile device, an IoT device, or a server system.

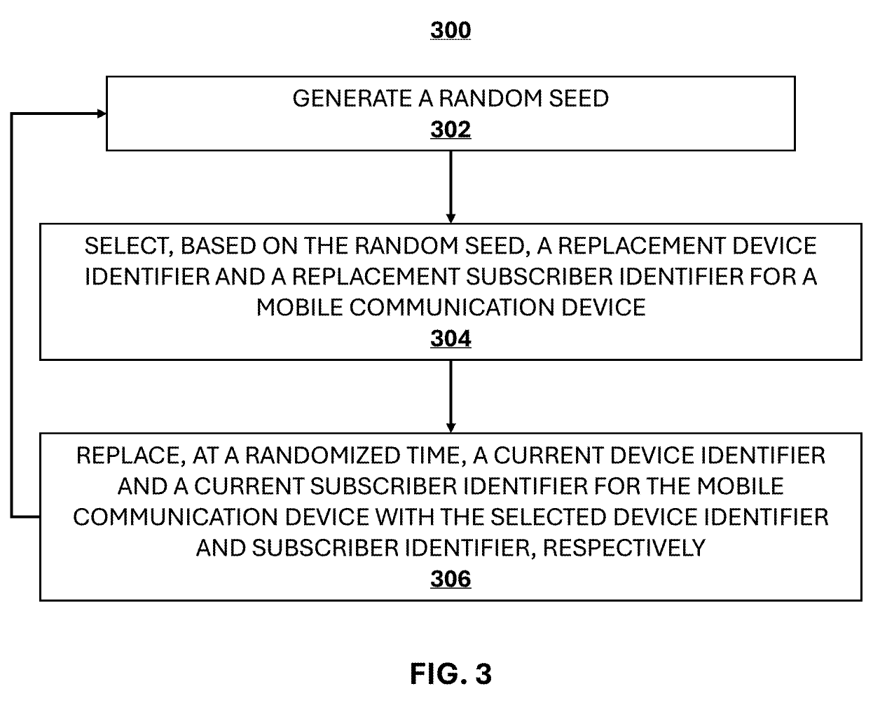

Referring to FIG. 3, a flow diagram for a method for obfuscating mobile communication device identity in accordance with the present disclosure is shown as 300. Although the steps of FIG. 3 are shown in a particular order, the steps need not all be performed in the specified order, and certain steps can be performed in another order. Further, FIG. 3 is described below, with controller 202 of FIG. 2 performing the operations. In aspects, the operations of FIG. 3 may be performed all or in part by another device, for example, a server, a mobile device, such as a smartphone, and/or a computer system. These variations are contemplated to be within the scope of the present disclosure.

Initially, at step 302, the system generates a random seed using the random number generator, e.g., of mobile communications device 100 (FIG. 1) or random number generator 204 of cloaking device 200 (FIG. 1).

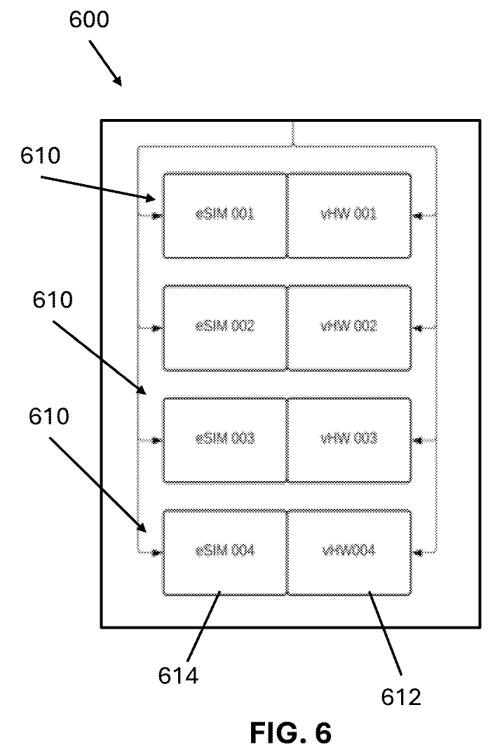

At step 304, the system selects, based on the random seed, a replacement device identifier and a replacement subscriber identifier for a mobile communication device. The replacement device and subscriber identifiers may be a combination of a device identifier and a subscriber identifier retrieved, e.g., randomly, from a set of combinations of device identifiers and subscriber identifiers, as detailed hereinbelow with reference to FIG. 6. The replacement device identifier and replacement subscriber identifier are different from the current device identifier and current subscriber identifier currently active on the mobile communication device. The device identifiers, in aspects, may include at least an IMEI and/or the subscriber identifiers, in aspects, may include at least an IMSI.

At step 306, the system replaces, at a randomized time, e.g., as determined by the random number generator, the currently active device and subscriber identifiers with the selected replacement device and subscriber identifiers for use by the mobile communication device.

Steps 302-306 may be repeated, at random, e.g., as determined by the random number generator, to repeatedly switch between different combinations of device identifiers and subscriber identifiers.

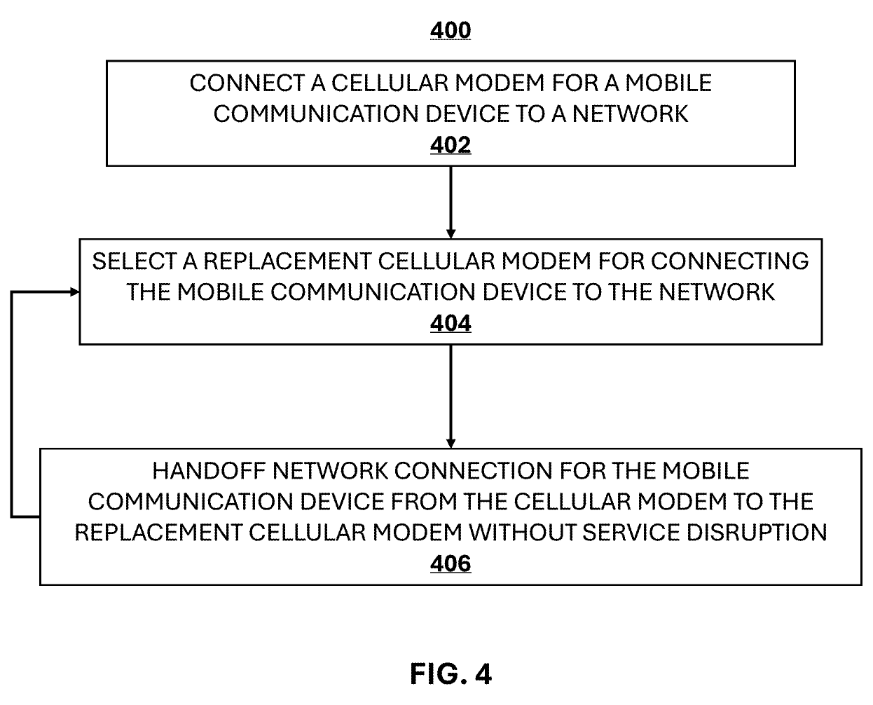

Referring to FIG. 4, a flow diagram for a method for obfuscating mobile communication device identity in accordance with the present disclosure is shown as 400. Although the steps of FIG. 4 are shown in a particular order, the steps need not all be performed in the specified order, and certain steps can be performed in another order. Further, FIG. 4 is described below, with controller 202 of FIG. 2 performing the operations. In aspects, the operations of FIG. 4 may be performed all or in part by another device, for example, a server, a mobile device, such as a smartphone, and/or a computer system. These variations are contemplated to be within the scope of the present disclosure.

Initially, at step 402, the system connects a cellular modem 206 (FIG. 1), e.g., cellular modem M₁, M₂, or Mₙ, for a mobile communication device 100 (FIG. 1) to a network, e.g., a cellular network.

At step 404, the system selects, based on a random seed generated by the random number generator or in another suitable random or other manner, a replacement cellular modem for connecting the mobile communication device to the network. The currently connected and replacement cellular modems can include different device and subscriber identifiers and, in aspects, methods 300 (FIG. 3) and 400 can operate together with one another for identity obfuscation.

At step 406, the system performs a handoff of network connection for the mobile communication device from the previously connected cellular modem to the replacement cellular modem without service disruption, e.g., without dropping an ongoing call.

Steps 404 and 406 may be repeated, at random, e.g., as determined by the random number generator, to repeatedly switch between different cellular modems.

Referring generally to FIGS. 1-4, in aspects, the system may start a call using a data connection using a first modem, e.g., a cellular modem M₁, M₂, or Mₙ of the plurality of cellular modems 206 of cloaking device 200. In aspects, the system may activate a first Session Initiation Protocol (SIP)-based communication terminal to enable the mobile communication device 100 to participate in Voice over IP (VoIP) messaging and, in aspects, assign a randomized first phone number to the mobile communication device 100.

In aspects, the system may activate and switch to a second SIP-based communication terminal using a second cellular modem, e.g., another cellular modem M₁, M₂, or Mₙ of the plurality of cellular modems 206 of cloaking device 200, and continue the call uninterrupted using a data connection using the second cellular modem. In such aspects, e.g., as part of the switch, the randomized first phone number may be replaced with a randomized second, different phone number and/or identifiers (e.g., device and/or subscriber identifiers) may be replaced with different identifiers.

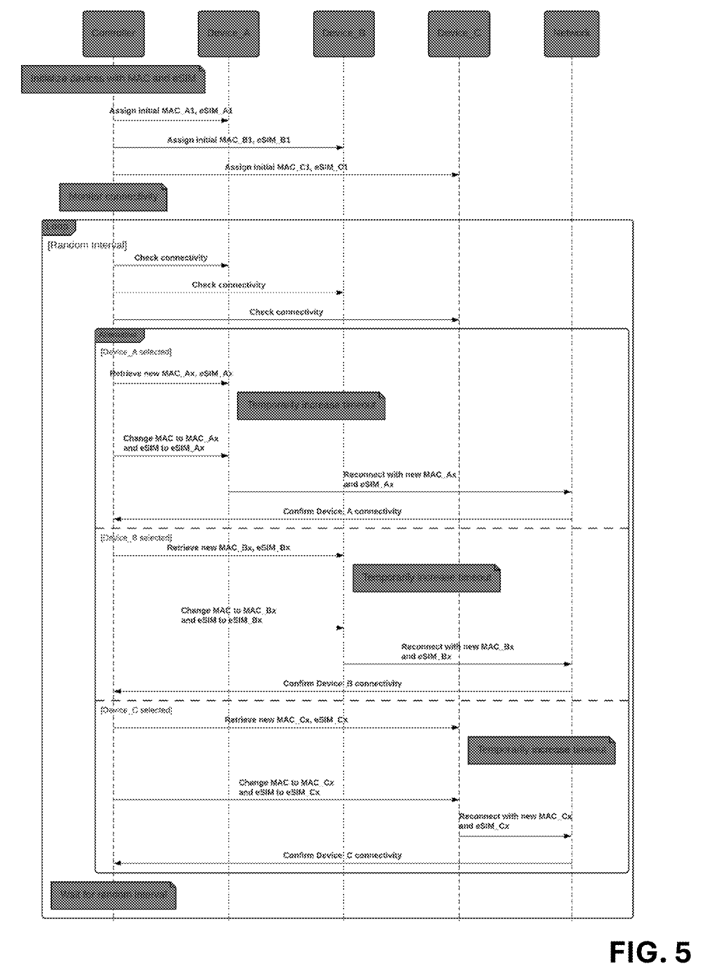

With reference to FIG. 5, in conjunction with FIG. 1, a schematic illustration of the communications between a controller in accordance with the present disclosure, e.g., controller 202 of cloaking device 200; three different cellular modems denoted as Device_A, Device_B, and Device_C, e.g., which may be cellular modem M₁, M₂, or Mₙ of the plurality of cellular modems 206 of cloaking device 200, although any suitable number of cellular modems may be utilized in accordance with the present disclosure; and a network, e.g., a cellular network. Controller 202 assigns an initial combination of identifiers (e.g., a device identifier and a subscriber identifier) to each cellular modem. Controller 202 may, at random intervals, re-assign different combinations of identifiers to each cellular modem. Controller 202 at random intervals, may switch between and/or check the connectivity of each of the cellular modems.

For each cellular modem, whether currently connected or not currently in use (e.g., where another of the cellular modems is currently connected), controller 202 may, at random intervals, retrieve a replacement combination of identifiers, change the combinations of identifiers for that cellular modem from the current combination of identifiers to the replacement combination of identifiers, and reconnect the cellular modem to the network using the replacement combination of identifiers. The network confirms the connectivity of the cellular modem to the network using the replacement combination of identifiers.

In aspects, the timeout is temporarily increased for each cellular modem to facilitate changing over from the current combination of identifiers to the replacement combination of identifiers. Further, as noted above, the combination switching within each cellular modem and/or the switching between cellular modems may occur at randomized intervals, as provided by the random number generator.

Referring to FIG. 6, as noted above, identity cloaking in accordance with the present disclosure enables replacing a current combination of device and subscriber identifiers with a replacement combination of device and subscriber identifiers. Each combination is capable of being presented to cellular networks as an authentic, standalone identity combination. In aspects, a plurality of combinations of identifiers 610 are stored as a pool of combinations in a memory 600 (such as, for example, a portion of the storage 210 of controller 202 (FIG. 2)) for retrieval of a (random) combination 610 from the pool of the plurality of combinations 610 when identifier switching is to occur. Each combination 610 includes a device identifier 612 (represented as a hardware identifier (vHW), although other configurations are also contemplated) and a subscriber identifier 614 (represented as an eSIM, although other configurations are also contemplated). The pool of the combinations 610 (and/or the identifiers 612, 614 separately), in aspects, may be obtained from abandoned mobile communication devices no longer in use such as, for example, mobile communication devices discarded, sent for recycling, abandoned, traded-in, or otherwise taken out of service. Utilizing combination 610 from devices previously used in service, e.g., connected to a cellular network, helps ensure that the combinations 610 are capable of being presented to and accepted by the cellular network for use. The identifiers 612 of the combinations 610, in aspects, may include at least an IMEI and/or the identifiers 614 of the combinations 610, in aspects, may include at least an IMSI.

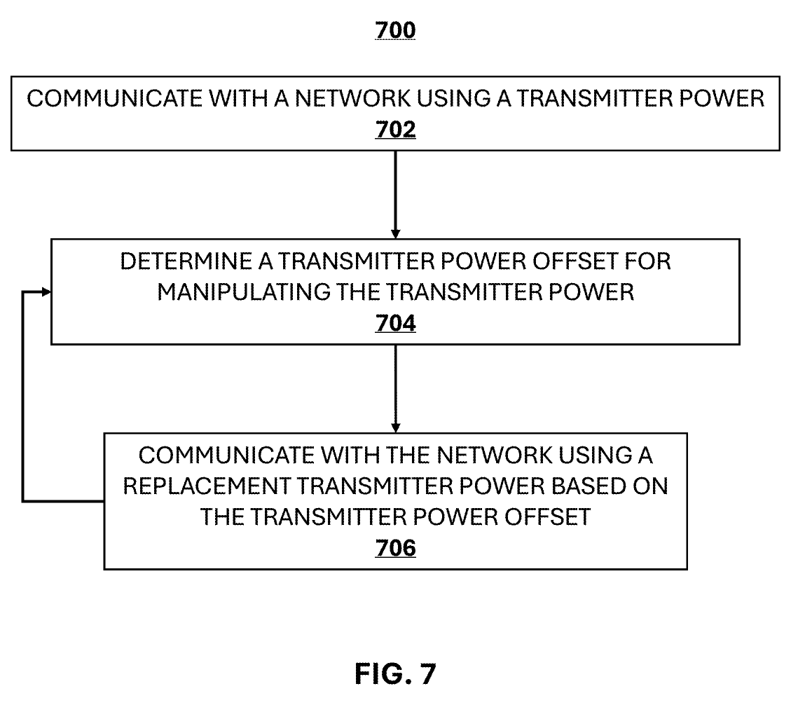

Turning to FIG. 7, in aspects, as noted above, the system may modify transmission signal power of the mobile communication device at randomized time intervals and/or randomized amounts to disrupt signal strength-based triangulation by cellular networks. A flow diagram for a method for obfuscating signal strength-based triangulation by cellular networks, thereby cloaking mobile communication device location, in accordance with the present disclosure is shown as 700. Although the steps of FIG. 7 are shown in a particular order, the steps need not all be performed in the specified order, and certain steps can be performed in another order. Further, FIG. 7 is described below, with controller 202 of FIG. 2 performing the operations. In aspects, the operations of FIG. 7 may be performed all or in part by another device, for example, a server, a mobile device, such as a smartphone, and/or a computer system. These variations are contemplated to be within the scope of the present disclosure.

Initially, at step 702, the system communicates with a network by transmitting signals using a transmitter power. As step 704, a transmitter power offset for manipulating the transmitter power is determined. The transmitter power offset may be a differential from the current transmitter power to a replacement transmitter power or may be the replacement transmitter power itself. At step 706, the system communicates with the network by transmitting signals using the replacement transmitter power. Steps 704 and 706 may be repeated, e.g., at randomized intervals or continuously, to thereby vary the transmission power level of the communication between the system and the work, thereby disrupting signal strength-based triangulation by cellular networks.

In aspects, the system maintains active connectivity to a cellular network during the above-detailed replacement of the identifiers (and/or cellular modems) as well as modification of the transmission signal power. In aspects, any or all of the randomization detailed herein may be provided from one or more random seeds generated by the random number generator.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects and features of the present disclosure may include all, some, or none of the enumerated advantages and/or other advantages not specifically enumerated above.

The aspects and features disclosed herein are examples of the disclosure and may be embodied in various forms. For instance, although certain aspects and features herein are described as separate, each of the aspects and features herein may be combined with one or more of the other aspects and features herein except as explicitly contradicted herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects and features described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for cloaking a mobile communication device, comprising:
a random number generator;
a plurality of cellular modems;
a controller; and
a memory storing instructions that, when executed by the controller, cause the system to:
select, at random, a replacement combination of identifiers for use in connecting a mobile communication device to a network, wherein the replacement combination of identifiers includes a device identifier and a subscriber identifier different from a device identifier and a subscriber identifier, respectively, of a current combination of identifiers currently used to connect the mobile communication device to the network; and
replace, at random, the currently active combination of identifiers with the selected replacement combination of identifiers for the mobile communication device.

2. The system according to claim 1, wherein at least one of the selection at random or the replacement at random is based on a random seed generated by the random number generator.

3. The system according to claim 1, wherein:
a first cellular modem of the plurality of cellular modems is used to connect the mobile communication device to the network using the current combination of identifiers,
a second cellular modem of the plurality of cellular modems has the selected replacement combination of identifiers assigned thereto, and
the replacing includes performing a handoff from the first cellular modem to the second cellular modem to connect the mobile communication device to the network using the second cellular mode and the replacement combination of identifiers.

4. The system according to claim 3, wherein the instructions, when executed by the controller, further cause the system to:
start a call using a first data connection to the network using the first cellular modem,
wherein performing the handoff includes switching from the first data connection using the first cellular modem to a second data connection to the network using the second cellular modem, and
continue the call using the second data connection using the second cellular modem.

5. The system according to claim 4, wherein starting the call using the first data connection includes assigning a first random phone number and wherein performing the handoff to continue the call using the second data connection includes assigning a second random phone number.

6. The system according to claim 1, wherein at least one of:
each device identifier includes at least an International Mobile Equipment Identity (IMEI); or
each subscriber identifier includes at least an International Mobile Subscriber Identity (IMSI).

7. The system according to claim 1, wherein the random number generator is a Quantum Random Number Generator (QRNG) or a Single-Photon Avalanche Diode (SPAD) sensor.

8. The system according to claim 1, wherein the replacement combination of identifiers is selected from a pool of combinations stored in a memory accessible by the controller, at least a portion of the pool of combinations obtained from previously used devices taken out of service.

9. The system according to claim 1, wherein the instructions, when executed by the controller, further cause the system to modify, at random, transmission signal power from the mobile communication device to disrupt signal strength-based triangulation.

10. The system according to claim 1, wherein the instructions, when executed by the controller, further cause the system to maintain active connectivity to the network during the replacement of the combination of identifiers.

11. The system according to claim 1, wherein the controller includes an FPGA or ASIC.

12. A mobile communication system, comprising:
a mobile communication device; and
the system of claim 1 incorporated into or connected with the mobile communication device.

13. A method for cloaking a mobile communication device, comprising:
selecting, at random, a replacement combination of identifiers for use in connecting a mobile communication device to a network, wherein the replacement combination of identifiers includes a device identifier and a subscriber identifier different from a device identifier and a subscriber identifier, respectively, of a current combination of identifiers currently used to connect the mobile communication device to the network; and
replacing, at random, the currently active combination of identifiers with the selected replacement combination of identifiers for the mobile communication device.

14. The method according to claim 13, wherein at least one of the selection at random or the replacement at random is based on a random seed generated by a random number generator.

15. The method according to claim 13, wherein the replacing includes performing a handoff from a first cellular modem to a second cellular modem to connect the mobile communication device to the network using the second cellular mode and the replacement combination of identifiers.

16. The method according to claim 15, further comprising:
starting a call using a first data connection to the network using the first cellular modem,
wherein performing the handoff includes switching from the first data connection using the first modem to a second data connection to the network using the second cellular modem, and
continuing the call using the second data connection using the second cellular modem.

17. The method according to claim 13, wherein at least one of:
each device identifier includes at least an International Mobile Equipment Identity (IMEI); or
each subscriber identifier includes at least an International Mobile Subscriber Identity (IMSI).

18. The method according to claim 13, wherein the replacement combination of identifiers is selected from a pool of combinations stored in a memory accessible by the controller, at least a portion of the pool of combinations obtained from previously used devices taken out of service.

19. The method according to claim 13, further comprising modifying, at random, transmission signal power from the mobile communication device to disrupt signal strength-based triangulation.

20. The method according to claim 13, further comprising maintaining active connectivity to the network during the replacement of the combination of identifiers.
